(19) United States
(12) Patent Application Publication
(10) Pub. No.: US 2002/0106154 A1
(43) Pub. Date: Aug. 8, 2002

(54) Apparatus for and method of jointing probes

(76) Inventor: Yasuhiro Tanaka, Tokyo (JP)

Correspondence Address: FLYNN, THIEL, BOUTELL & TANIS, P.C., 2026 Rambling Road, Kalamazoo, MI, 49008-1699, US

(21) Appl. No.: 10/058,941

(22) Filed: Jan. 28, 2002

(30) Foreign Application Priority Data
Jan. 29, 2001 (JP) 2001-20479

(51) Int. Cl. G02B 6/32; G02B 6/26; H01S 3/00; H01S 3/10

(52) U.S. Cl. 385/33; 385/31; 372/9; 372/109

(57) ABSTRACT

In the case where a central interval between the adjacent connection pads at the center thereof is smaller than the diameter of a beam spot of laser light and the length of each connection pad is several times as long as the central interval, the laser light can be irradiated entirely uniformly onto a desired connection pad without irradiating the laser light onto the adjacent connection pads and an interval between the condenser and the irradiation portion (connection pad) can be prevented from getting too close to each other. A probe jointing apparatus is provided with laser emitting means, a condenser for condensing laser light emitted from the laser emitting means at a jointing portion between the connection pads and the probes, and light path interception means for intercepting a part of light path of the laser light, wherein a beam spot of the laser light is trimmed by the light path interception means to be irradiated onto a desired connection pad.

### TECHNICAL FIELD OF THE INVENITON

The invention relates to an apparatus for and a method of jointing probes connected to a semiconductor integrated circuit so as to be conductive with the semiconductor integrated circuit to connection pads formed on a substrate by laser soldering.

### BACKGROUND OF THE INVENTION

The miniaturization of electronic devices makes remarkable progress recently and the demand for the miniaturization of semiconductor integrated circuits to be mounted on the electronic devices has increased. To meet the demand, there has been developed a method of mounting the semiconductor integrated circuits directly on a circuit board in a state where the semiconductor integrated circuits are cut from a semiconductor wafer (bare chip), and there has been desired bear chips which are guaranteed in quality.

It is necessary that all the semiconductor integrated circuits are subjected to a bun-in-screening in a bare chip state so as to guarantee the quality of the bare chip. The semiconductor integrated circuits are required to be effectively subjected to a burn-in-screening in a lump in a wafer state before they are cut as the bare chip.

It is necessary to apply a power supply voltage and signals to multiple chips formed on the same wafer at the same time to operate the multiple chips in order to subject the bare chips to a burn-in-screening in a lump in a wafer state. To this end, it is necessary to prepare a probe card having several thousand probes. However, a conventional needle type probe card has a problem in that it can not meet the requirement set forth above in view of the number of pins and costs thereof.

To meet the requirement, the applicant of this invention has proposed a probe card as disclosed in Japanese Patent Application No. 2000-186584 and as illustrated in FIG. 11 of this application. This probe card includes multiple probes 3 to be connected to testing electrodes for testing a semiconductor wafer and a substrate 1 electrically connected to the probes 3, wherein the probes 3 are jointed to connection pads 2 formed on the substrate 1 by soldering. There is employed, for example, a soldering device shown in FIG. 12 so as to joint the probes 3 to the connection pads 2 formed on the substrate 1. The substrate 1 is a wiring board having wirings or leads for applying a power supply voltage, signals, and the like to semiconductor integrated circuits so as to be conductive therewith.

In FIG. 12, depicted by 3 is probes, 1 is a substrate, 2 is connection pads, 106 is a semiconductor laser, 105 is a fiber, and 104 is a condenser.

The semiconductor laser 106 has been widely used in the laser soldering device, and it can output laser light through a fiber (fiber output) having 808 nm in a wavelength, 15W to 20W in an output, 600 μm in a core diameter, 0.2 to 0.22 in a NA (the number of apertures). An oscillation type or mode of laser is multimode.

The semiconductor laser 106 having this waveband is used for exciting a YAG laser having multimode in an oscillation mode and hence it has a disadvantage that light is hardly incident onto a fiber having a small core diameter, but has an advantage that a high laser output can be available at a low cost and workability with respect to solder is excellent.

A fiber output has an advantage that the distance between the semiconductor laser 106 and a tip end 105a of the fiber 105 is set apart and the degree of freedom of the arrangement of the components is rendered high when the components are built in the laser soldering device. However, the core diameter of the fiber 105 is limited and a large number of multimode fibers each having a core diameter of 600 μm have been used.

With the laser soldering device as described above, the probes 3 are jointed to the connection pads 2 formed on the substrate 1 in the following manner. As shown in FIG. 11, solder 2b is applied onto the connection pads 2 in advance. As shown in FIG. 12, laser light emitted from the semiconductor laser 106 is guided through the fiber 105 and condensed by the condenser 104. The condensed laser light is irradiated onto each connection pad 2 to fuse the solder 2b while the probes 3 are pressed onto each connection pad 2, thereby jointing the probes 3 to the connection pads 2.

However, the conventional laser soldering device has the following problems. Suppose that an interval between the adjacent connection pads at the center thereof (hereinafter referred to central interval) is smaller than the diameter of a beam spot of the laser light and the length of each connection pad is several times as long as the central interval. For example, suppose that the central interval P of the adjacent connection pads 2, 2 is 100 μm, each length L of the connection pad 2 is 500 μm, and the diameter of the beam spot at the irradiation position is 600 μm, a beam spot probe 71 is irradiated onto multiple connection pads 2 shown in FIG. 14. In this case, if there are probes 3 which have been already jointed to the adjacent connection pads 2, the jointing therebetween is worked off. Accordingly, the diameter of the beam spot of the laser light to be irradiated has to be within the width of one connection pad 2. In this case, the diameter of the beam spot is 100 μm.

Suppose that the core diameter of the fiber d1 is 600 μm, it is necessary that a condenser has a reduction ratio with an imaging scale of 6:1 in order to condense the beam spot of the laser light to the extend of diameter, e.g. of 100 μm. A case where the condenser is constituted by two pieces of lenses is illustrated in FIG. 17. The imaging scale becomes the ratio of focal distances f1, f2. For example, in FIG. 17, suppose that the focal distance f1 of the first lens 104a becomes 60 mm, and the focal distance f2 of the second lens 104b becomes 10 mm, the imaging scale becomes 6:1 so that the laser light emitted from the core 105c having the diameter d1 can be condensed to an image d2 having the diameter of the beam spot of 100 μm.

However, the focal distance f2 of the second lens 104b is very short, i.e. 10 mm, and hence the distance h1 between the second lens 104b and the substrate 1 becomes 10 mm as shown in FIG. 18 so that the second lens 104b is smeared by gas or scatter object produced when the laser soldering is effected, thereby causing a problem of the deterioration of the laser light and the generation of baking of the lens.

Although there is a method for lengthening the focal distance between the first lens 104a and the second lens 104b, this causes a problem that the aperture D of the lens becomes very large.

Further, as shown in FIG. 19, when the laser light having the diameter of the beam spot 70 of 100 μm is irradiated onto the connection pad 2 having a length of 500 μm, the connection pad 2 is locally heated so that the temperature distribution of the connection pad does not become uniform as shown in the graph of FIG. 20. In order to increase the temperature of a part of the connection pad 2, onto which the laser light is not irradiated (hereinafter referred to as non-irradiation portion), to a temperature suitable for soldering, a laser output is increased to increase the temperature of the irradiation portion, thereby transferring the heat to the non-irradiation portion by heat conduction. However, if the laser output is too increased, the temperature of the solder on the radiation portion of the connection pad 2 is increased too much, so that sublimation occurs, thereby destructing the connection pads 2 and the substrate 1. On the other hand, if the laser output is low, there occurs a problem that the temperature of the non-irradiation portion is not increased to a required temperature.

### SUMMARY OF THE INVENTION

In view of the foregoing circumstances, it is an object of the invention to enable laser light to be irradiated entirely uniformly onto a desired connection pad and to prevent a condenser and an irradiation portion (connection pad) from getting too close to each other without irradiating the laser light onto the adjacent connection pads, in the case where the central interval is narrower than the diameter of a beam spot of the laser light and the length of the connection pad is several times as large as the central interval.

To achieve the above object, the apparatus for jointing probes connected to a semiconductor integrated circuit so as to be conductive therewith to connection pads 2 formed on a substrate 1 by laser soldering according to the first aspect of the invention is characterized in comprising, for example, as shown in FIG. 1 and FIG. 2, laser emitting means 6 serving as a heat source, a condenser 4 for condensing laser light emitted from the laser emitting means 6 at a jointing portion between the connection pads and the probes, and light path interception means 4C for intercepting a part of light path of the laser light to trim a beam spot of the laser light.

The substrate has multiple wirings (leads) to apply a power supply voltage, signals and the like to multiple semiconductor integrated circuits formed on a semiconductor wafer. Many connection pads (e.g. several thousands) are formed on the substrate and respective wirings are connected to the corresponding connection pads 2.

According to the first aspect of the invention, although the laser light emitted from the laser emitting means is condensed by the condenser 4, at that time the beam spot of the laser light is trimmed by intercepting a part of light path of the laser light by the light path interception means 4C and irradiated onto the jointing portion (solder on the connection pad) between the connection pads 2 and the probes 3. That is, the shape of the beam spot of the laser light is trimmed so as to be equal to or slightly larger than the shape of the jointing portion. Consequently, even if the central interval between the adjacent connection pads 2 has a narrow pitch, e.g. of not more than 100 μm, it is possible to irradiate a laser light entirely onto the desired connection pad 2 uniformly and prevent the laser light from being irradiated onto the adjacent connection pads 2. Further, the laser light can be irradiated entirely onto each connection pad 2, a condenser having a long focal distance can be used and the distance between the condenser 4 and the irradiation portion can be sufficiently assured.

The second aspect of the invention is characterized in that in the apparatus for jointing probes (hereinafter referred to as a probe jointing apparatus) according to the first aspect of the invention, the laser light emitted from the laser emitting means 6 is led to the condenser 4 through a fiber 5.

According to the second aspect of the invention, although the laser light is led to the condenser 4 through the fiber 5, even if the diameter of the core of the fiber is several times as large as the central interval between the adjacent connection pads, the beam spot of the laser light is trimmed by the light path interception means, thereby irradiating onto the jointing portion (solder on the connection pad) between the connection pad 2 and the probe 3. Accordingly, the laser light can be irradiated entirely onto the connection pads 2 uniformly, and the laser light can be prevented from being irradiated onto the adjacent connection pads so that a condenser having a long focal distance can be used and the distance between the condenser and the irradiation portion can be satisfactorily secured. Further, since the laser light is led to the condenser through the fiber, there is an advantage that the distance between the laser emitting means and the tip end of the fiber is set apart and the degree of freedom of the arrangement of the components is high when the components are built in the laser soldering device.

The third aspect of the invention is characterized in that in the probe jointing apparatus of the first or second aspect of the invention, for example, as shown in FIG. 7 and FIG. 9, the light path interception means 4C is tuned about a light axis 8 at a face perpendicular to the light path to change a direction of the beam spot at an irradiated portion.

According to the third aspect of the invention, since the direction of the beam spot can be changed by turning the light path interception means about a light axis at the face perpendicular to the light path while the attachment position of the condenser is fixed, the beam spot can be matched with the connection pad (jointing portion) without moving the attachment position of the condenser.

A method of jointing probes 3 connected to a semiconductor integrated circuit so as to be conductive therewith to connection pads 2 formed on a substrate 1 by laser soldering according to the fourth aspect of the invention is characterized in comprising, for example, as shown in FIG. 1 and FIG. 2, trimming a beam spot of laser light by intercepting a part of light path of the laser light when the laser light is condensed to irradiate the laser light onto a jointing portion between the connection pads 2 and the probes 3.

According to the fourth aspect of the invention, the beam spot of laser light is trimmed by intercepting the part of light path of the laser light when the laser light is condensed to irradiate the laser light onto a jointing portion between the probes 3 and the connection pads 2. That is, the beam spot of the laser light is irradiated while the shape of the beam spot is trimmed to be rendered substantially the same or slightly larger than the shape of the jointing section (connection pad). Consequently, even if the central interval between the adjacent connection pads has a small pitch, e.g. of not more than 100 μm, the laser light can be irradiated entirely onto the desired connection pad uniformly, and the irradiation of the laser light onto the adjacent connection pads can be prevented. The method of jointing probes according to the fourth aspect of the invention can be easily realized using the probe jointing apparatus of the first aspect of the invention.

The fifth aspect of the invention is characterized in that in the method of jointing probes (hereinafter referred to as probe jointing method) according to the fourth aspect of the invention, a direction of the beam spot is changed at the irradiation portion when a part of the light path of the laser light is intercepted.

According to the fifth aspect of the invention, a direction of the beam spot is changed at the irradiation portion when a part of the light path of the laser light is intercepted, thereby allowing the beam spot to match with the connection pad (jointing portion).

### BRIEF DESCRIPTION OF THE DRAWINGS

FIG. 1 is a view showing a schematic configuration of a probe jointing apparatus according to a first embodiment of the invention.

FIG. 2 is a side view of the probe jointing apparatus according to the first embodiment.

FIG. 3 is a partial plan view showing the configuration of a condenser according to the first embodiment.

FIG. 4 is a partial perspective view showing an example of light path interception means according to the first embodiment.

FIG. 5 is a graph showing a temperature distribution on the connection pad together with the connection pad according to the first embodiment.

FIG. 6 is a view showing a distance between the condenser and a substrate when using the probe jointing apparatus according to the first embodiment.

FIG. 7 is a view for explaining a case where the light path interception means is turned according to the first embodiment.

FIG. 8 is a partial side view for explaining a case where laser light is irradiated onto the substrate using the condenser according to the first embodiment.

FIG. 9 is a partial plan view for explaining a case where a direction of a beam spot is changed when the light path interception means is turned according to the first embodiment.

FIG. 10 is a side view of a probe jointing apparatus according to a second embodiment of the invention.

FIG. 11 is a partial perspective view showing the configuration of a probe card.

FIG. 12 is a partial side view showing a conventional probe jointing apparatus.

FIG. 13 is a partial plan view showing dimensions of arranged connection pads according to a conventional probe jointing apparatus.

FIG. 14 is a partial plan view showing longitudinal length of each connection pad and explaining a case where laser light having the same size as the longitudinal length of each pad is irradiated onto the connection pads.

FIG. 15 is a partial plan view showing a case where the diameter of the beam spot of the laser light is reduced so that laser light is not irradiated onto the adjacent connection pads.

FIG. 16 is a partial perspective view showing a configuration of an optical connector at the tip end of a fiber.

FIG. 17 is a partial side view showing a configuration of a conventional focal lenses.

FIG. 18 is a partial side view showing a distance between the condenser and a substrate when the conventional probe jointing apparatus was used.

FIG. 19 is a partial perspective view showing a state where laser light is irradiated onto a connection pad according to the conventional probe jointing apparatus.

FIG. 20 is a graph showing a temperature distribution on the connection pad together with the connection pad when the laser light is irradiated onto the connection pad according to the conventional probe jointing apparatus.

### PREFERRED EMBODIMENTS OF THE INVENITON

Embodiments of the invention are now described with reference to the attached drawings.

First Embodiment:

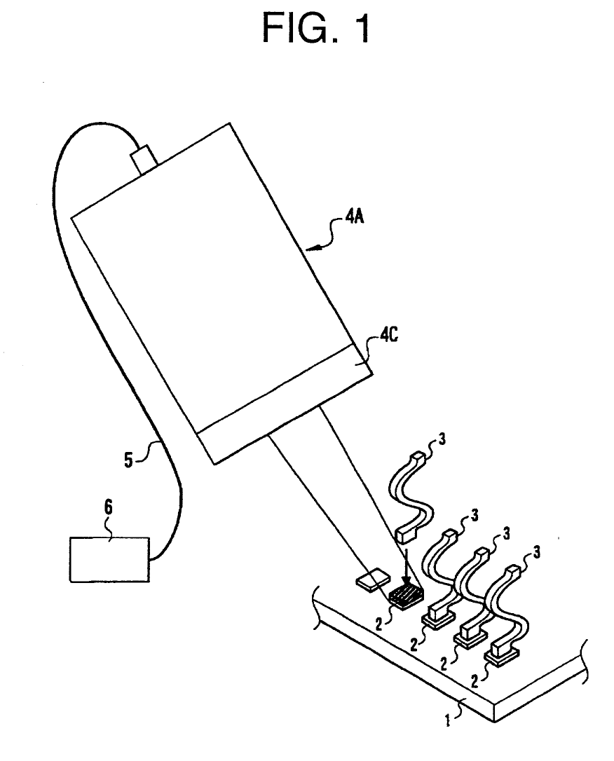

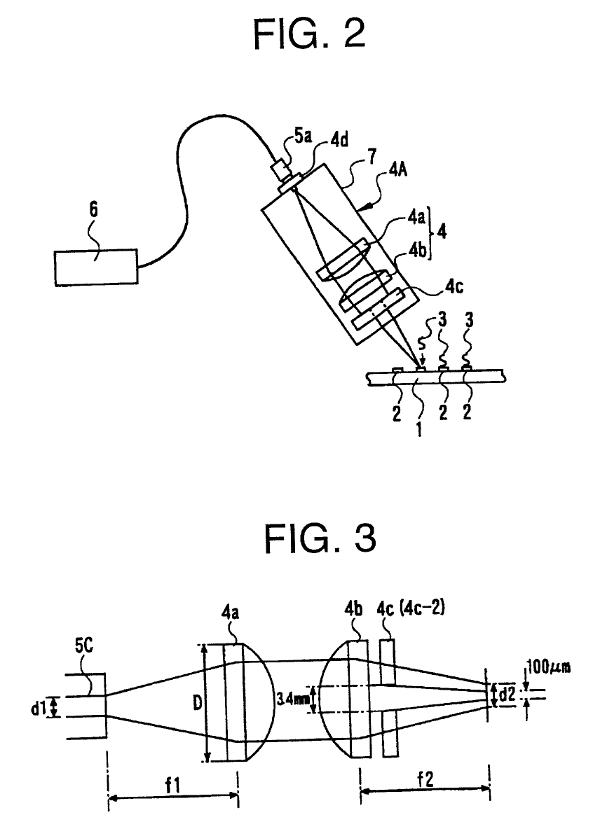

In FIG. 1 and FIG. 2, depicted by 1 is a substrate, 2 is connection pads, 3 is probes, 6 is a semiconductor laser (laser emitting means), 5 is a fiber, 4A is a condenser section, and 4C is light path interception means.

The substrate 1 has multiple wirings (leads) so as to apply a power supply voltage, signals and the like to the semiconductor integrated circuits at the same time when subjecting multiple semiconductor integrated circuits formed on the semiconductor wafer to a burn-in screening. Further, as shown in FIG. 1, multiple (e.g. several thousands) connection pads 2 are formed on the surface of the substrate 1 wherein respective wirings are connected to the corresponding connection pads 2 so as to appropriately effecting the burn-in-screening.

The connection pads 2 are jointed to the probes 3 by laser soldering. The probes 3 contact the testing electrodes of the semiconductor wafer under pressure for supplying signals and the like outputted from the substrate 1 to the semiconductor integrated circuits.

The laser emitting means 6 is a semiconductor laser having, e.g. an output of 40W, a wavelength of 808 nm. An oscillation mode of the laser emitting means 6 is a multimode and forms an optical module so that the laser output thereof is incident onto the fiber 5.

The fiber 5 is an optical fiber having, e.g. a core diameter of 600 μm, NA of 0.2. The fiber 5 is connected to the condenser section 4A by an optical connector 5a and an optical receptacle 4d and emits the laser light onto the condenser 4 with a spread angle (half angle) of sin ⁻¹0.2=11.537°. Since the laser light is led to the condenser 4 through the fiber 5, there is an advantage that the distance between the laser emitting means 6 and the tip end of the fiber 5 is set apart and the degree of freedom of the arrangement of the components is high when the components are built in the laser soldering device.

The condenser section 4A includes a case 7, the condenser 4 disposed inside the case 7 and a light path interception means 4C. The condenser 4 comprises a first lens 4a for rendering the laser light emitted from the optical connector 5a to become parallel light and a second lens 4b for condensing the parallel light emitted from the first lens 4a. The light path interception means 4C is disposed immediately after the second lens 4b. The light path interception means 4C has a function to trim the beam spot of the laser light by partially intercepting the light path of the laser light outputted from the second lens 4b.

The configuration of the condenser 4 is described with reference to FIG. 3. For example, both the first lens 4a and second lens 4b use a plane-convex lens having a focal distance f1=f2=50 mm, and a diameter D=25.4 mm, and they are disposed while opposing each other at the convex portion having circular arc in cross section.

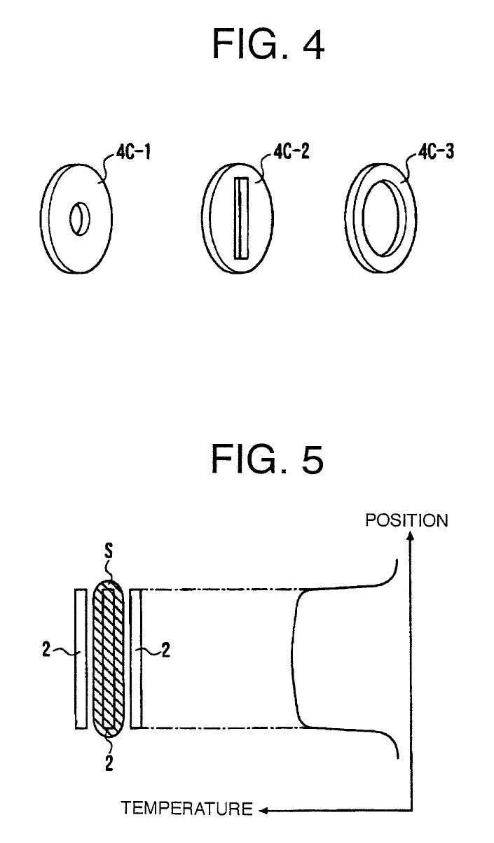

An example of the light path interception means 4C is illustrated in FIG. 4. FIG. 4 shows three types of light path interception means 4C-1, 4C-2, 4C-3, each having a hole at the center of the circular plate. The shape of the hole of the light path interception means 4C-1 is circular, the shape of the hole of the light path interception means 4C-2 is rectangular and the shape of hole of the light path interception means 4C-3 is elliptical. For the circular plate, an aluminum plate processed by black alumite, and the like are used. The circular plate may be made of any material if hardly reflects the laser light and is not changed in state even if it absorbs the laser light. Although the light path interception means 4C is disposed immediately after the second lens 4b in FIG. 3, but it may be disposed at the front of the first lens 4a (left side in FIG. 3) or between the first lens 4a and the second lens 4b.

The size of the hole of the light path interception means 4C is determined in the following manner. Described first is a case of the light path interception means 4C-2 having a rectangular shape. The beam spot dimensions are determined first in the case where there is no light path interception means 4C-2 at the irradiation position. As shown in FIG. 3, suppose that the irradiation position is the focal distance f2, the beam spot diameter d2 at the irradiation position is found by the following expression since the core diameter d1=600 μm, the focal distance f1 of the first lens 4a is f1=50 mm, and the focal distance f2 of the second lens 4b is f2=50 mm.

d2=d1×f2/f1

from this expression, d2=600 μm is established.

The ratio with respect to the required beam spot is determined. Suppose that the required beam spot is rectangle having the size of 600 μm ×100 μm, the required beam spot is established as 100/600=⅙ with respect to the original spot diameter d2 since the laser light is cut from original spot diameter 600 μm to 100 μm in one side.

The diameter of laser light at the position where the light path interception means 4C-2 is disposed is calculated next. Suppose that the diameter of the laser light has the same value at the parallel light beam immediately after the second lens 4b while the light path interception means 4C-2 is disposed in intimate contact with the second lens 4b so as to simplify the calculation. The beam spot d2 of the laser light at the portion immediately after the second lens becomes as follows.

d=f1×tan(sin⁻¹0.2)×2

from this expression, d=20.4 mm is established.

Then, the size of the hole is determined so that it becomes the foregoing ratio.

20.4×⅙=3.4 mm

From these expressions, the hole of the light path interception means 4C-2 becomes rectangular with the size of 20.4 mm×3.4 mm.

With the probe jointing apparatus according to the invention, the laser light emitted from the fiber core 5c having the diameter d1 becomes parallel light by the first lens 4a disposed at the focal distance f1, and the parallel light emitted from the first lens duct 4a is incident onto the second lens4b. The laser light emitted from the second lens 4b is partially intercepted by the light path interception means 4C-2 so that the beam spot of the laser light is trimmed and is irradiated onto the jointing portion (solder on the connection pad) between the connection pad 2 and the probe 3. That is, the laser light is irradiated onto the jointing portion while trimmed to become substantially the same as or slightly large than the shape of the jointing portion (connection pad). According to the first embodiment, the laser light becomes a rectangular beam spot S having the size of 600 μm×100 μm at the condensing position.

Accordingly, even if the central interval between the connection pads 2. 2 is a small pitch, e.g. of not more than 100 μm, it is possible to irradiate laser light entirely onto the desired connection pad 2 uniformly and prevent the laser light from irradiating onto the adjacent connection pads. Further, laser light can be irradiated entirely onto the connection pad 2 uniformly by the light path interception means 4C-2, so that a condenser having a long focal distance can be used and the distance between the condenser and the irradiation portion can be satisfactorily secured. Still further, the laser light can be irradiated entirely onto the connection pad 2 uniformly, so that the temperature distribution of the connection pad 2 becomes uniform as shown in FIG. 5, thereby soldering the probe 3 onto the connection pad 2 without fail.

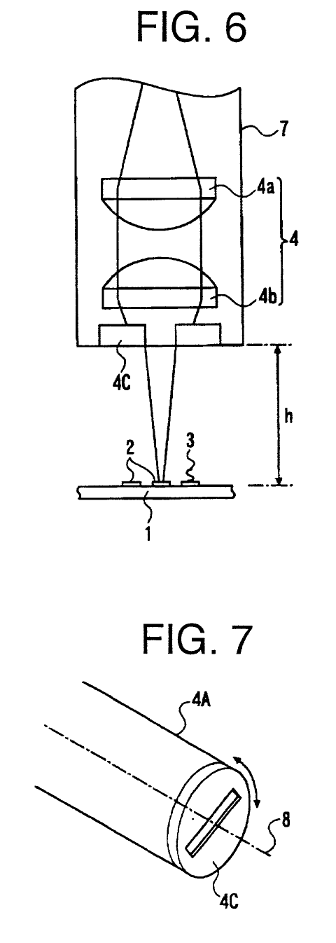

FIG. 6 shows a state where laser light is irradiated onto the connection pad 2 by the probe jointing apparatus according to the first embodiment. According to the first embodiment, the focal distance between the first lens 4a and second lens 4b is rendered to be 50 mm, thereby securing a distance h of 40 several mm between the lower end of the condenser 4 and the substrate 1.

FIG. 7 is a view for explaining an example for turning the light path interception means 4C. In FIG. 7, depicted by 4A is a condenser section provided with a condenser section therein, 8 is a light axis and 4C is light path interception means. The light path interception means 4C is attached to a face perpendicular to the light path and the attachment position can be turned about the light axis 8.

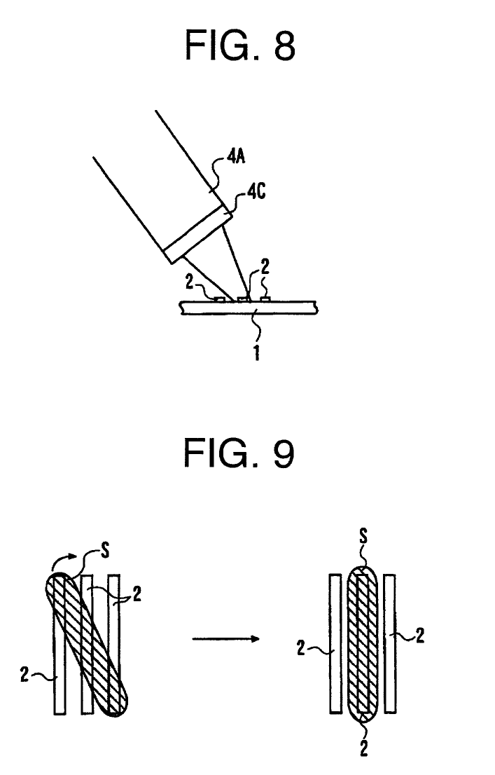

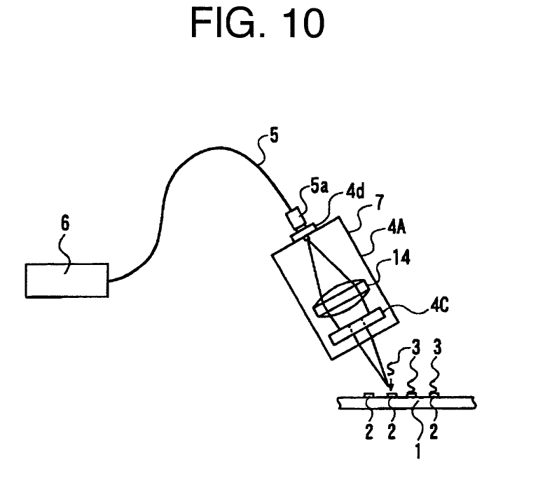

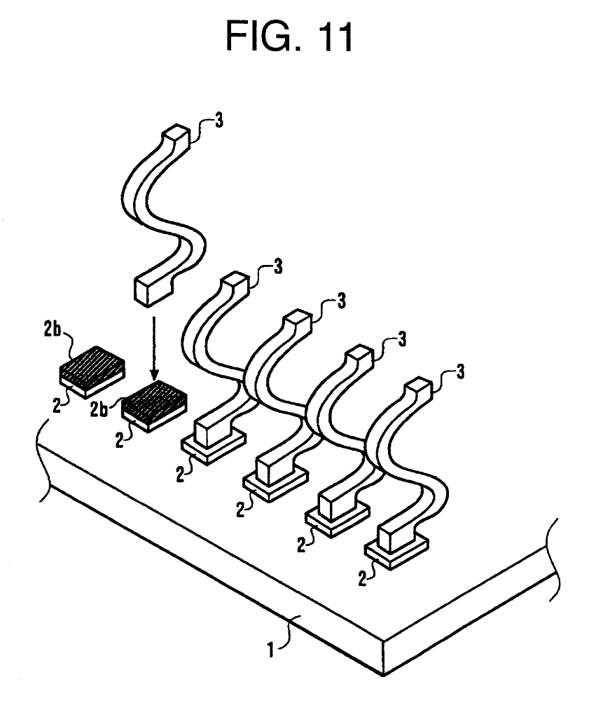

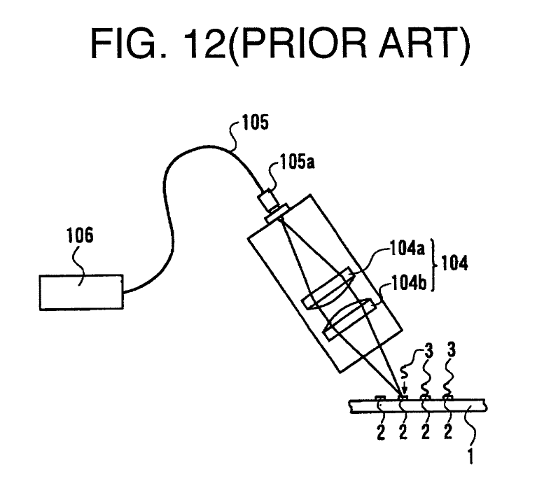

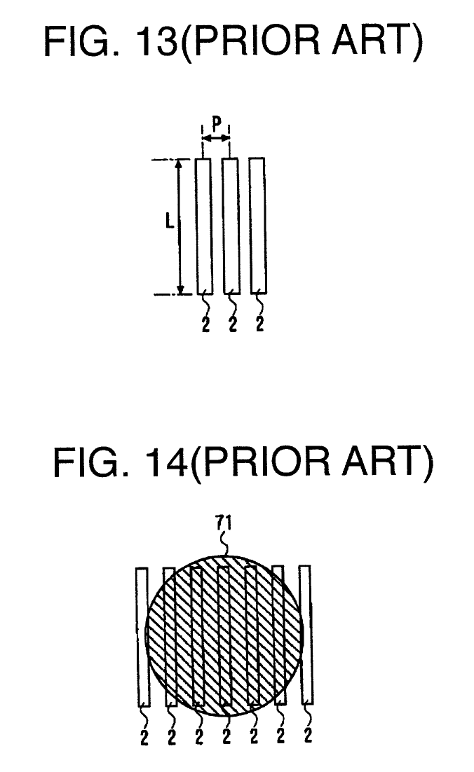

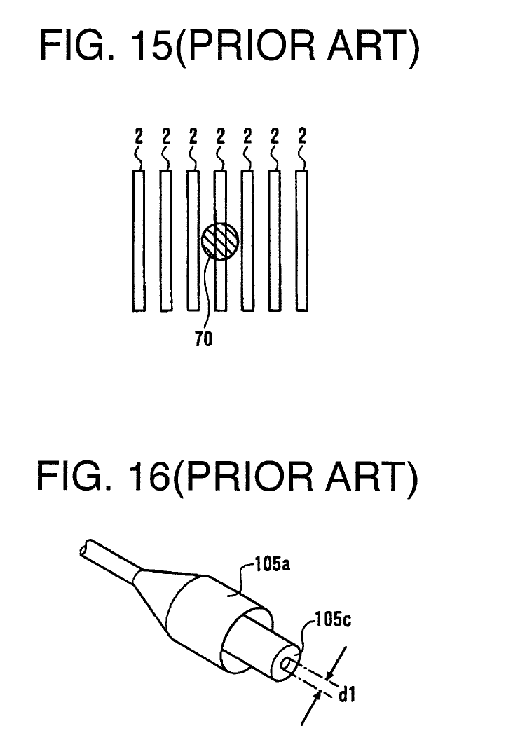

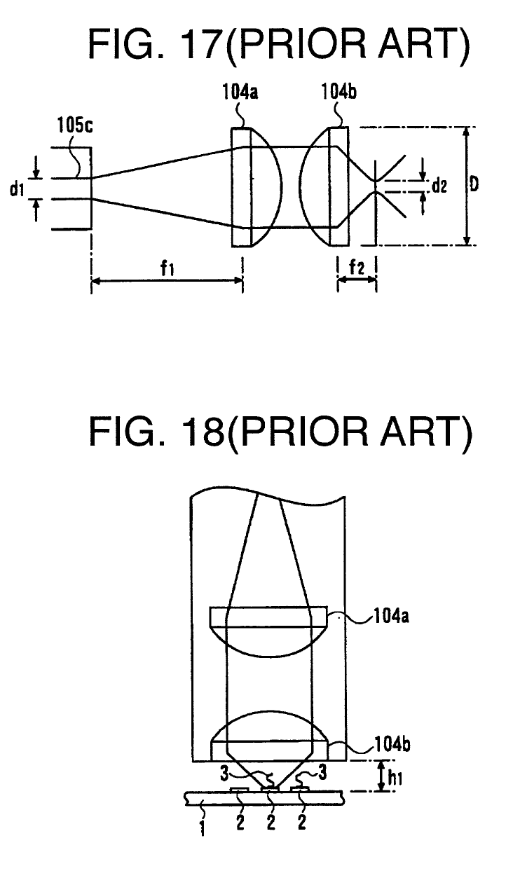

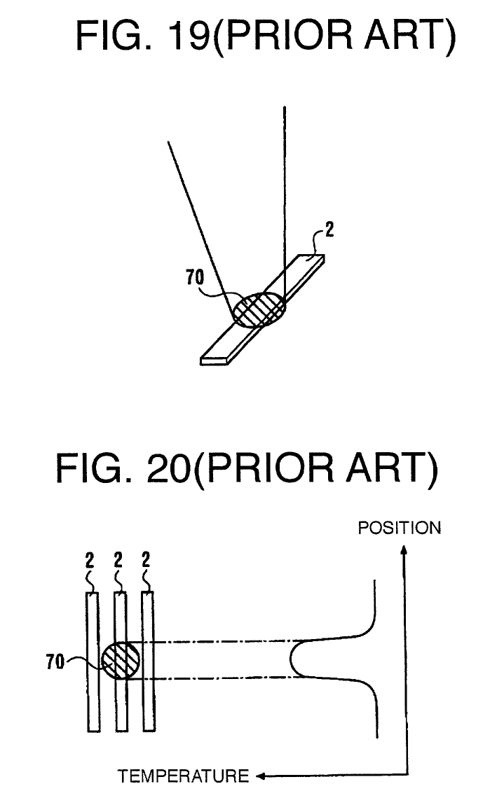

FIG. 8 shows an example for attaching the condenser section 4A to the substrate 1 aslant. When the condenser section 4A is fixed, there is a case where the direction of the beam spot S is aslant with respect to the longitudinal direction of the connection pad 2 at the irradiation position as shown in FIG. 9. In this case, when the light path interception means 4C is turned, the direction of the beam spot S can be adjusted to prevent the laser light from being irradiated onto the adjacent connection pads 2 by rendering the longitudinal direction of each connection pad 2 and that of the beam spot to be parallel with each other while the condenser section 4A is rendered fixed. That is, the beam spot S can be matched with the connection pads 2 without moving the attachment position of the condenser section 4A (condenser 4).

Second Embodiment:

FIG. 10 shows a second embodiment of the invention. In FIG. 10, components which are the same as those of the first embodiment are depicted by the same reference numerals and the explanation thereof is omitted. The second embodiment is different from the first embodiment in respect of the structure of a condenser formed of a piece of double-convex lens 14.

In the case of the structure comprised of a piece of double-convex lens 14, the double-convex lens 14 is disposed at the position remote from the light emitting point twice as long as the focal distance, thereby forming a 1:1 imaging condenser. According to the second embodiment, the double-convex lens 14 having the focal distance of 25.4 mm and the diameter of the lens is 25.4 mm is employed and disposed apart from the emitting end of the fiber by 50.8 mm, thereby obtaining the condensing position apart from the emitting side of the double-convex lens 14 by 50.8 mm.

The laser light emitted from the double-convex lens 14 is trimmed by the light path interception means 4C in an arbitrary shape and size, and is condensed. The position of the light path interception means 4C may be disposed at the incident side of the double-convex lens 14 in the same manner as the first embodiment of the invention.

According to the second embodiment, since the condenser is formed of a piece of double-convex lens 14, there is an advantage that the lens can be easily arranged in the case 7 in addition to the same effect as the first embodiment. Further, since the focal distance of the condenser 4a is set as 25.4 mm, the distance h of 40 several mm can be secured between the lower end of the condenser 4 and the substrate 1.

The second embodiment may be structured such that the direction of the beam spot can be changed by turning the light path interception means 4C in the same manner as the first embodiment.

According to the first aspect of the invention, since the beam spot of the laser light is trimmed by intercepting a part of the light path of the laser light by the light path interception means to irradiate onto the jointing portion between the connection pads and the probes, so that the beam spot of the laser light can be irradiated onto the jointing portion while it is trimmed to have the shape substantially the same or slightly larger than the shape of the jointing portion. Accordingly, even if the central interval between the adjacent connection pads has a small pitch, the laser light can be irradiated entirely onto the desired connection pad uniformly, and the irradiation of the laser light onto the adjacent connection pads can be prevented. Further, the laser light can be prevented from being irradiated onto the adjacent connection pads but can be irradiated entirely onto the desired connection pad uniformly so that a condenser having a long focal distance can be employed and the distance between the condenser and the irradiation portion can be satisfactorily secured.

According to the second aspect of the invention, even if the core diameter of the fiber is several times as long as the central interval, the beam spot of the laser light is trimmed by the light path interception means to be irradiated onto the jointing portion between the connection pads and the probes, and the laser light can be prevented from being irradiated onto the adjacent connection pads so that a condenser having a long focal distance can be used and the distance between the condenser and the irradiation portion can be satisfactorily secured. Further, since the laser light is led to the condenser through the fiber, the distance between the laser emitting means and a tip end of the fiber can be set apart and the degree of freedom of the arrangement of the components is high when the components are built in the laser soldering device.

According to the third aspect of the invention, since the direction of the beam spot can be changed by turning the light path interception means about a light axis while the attachment position of the condenser is fixed, the beam spot can be matched with the shape of the connection pad without moving the attachment position of the condenser.

According to the fourth aspect of the invention, since the beam spot of the laser light is trimmed by intercepting a part of the light path of the laser light so as to be irradiated, so that the beam spot of the laser light can be irradiated onto the jointing portion while it is trimmed to have the shape substantially the same or slightly larger than the shape of the jointing portion. Accordingly, even if the central interval between the adjacent connection pads has a small pitch, the laser light can be irradiated entirely onto the desired connection pad uniformly, and the irradiation of the laser light onto the adjacent connection pads can be prevented.

According to the fifth aspect of the invention, since the direction of the beam spot at the irradiation portion can be changed, the beam spot can be matched with the shape of the connection pad.

What is claimed is:

1. An apparatus for jointing probes connected to a semiconductor integrated circuit so as to be conductive therewith to connection pads formed on a substrate by laser soldering, said apparatus comprising:
laser emitting means serving as a heat source;
a condenser for condensing laser light emitted from the laser emitting means at a jointing portion between the connection pads and the probes; and
light path interception means for intercepting a part of light path of the laser light to trim a beam spot of the laser light.

2. The apparatus according to claim 1, wherein the laser light emitted from the laser emitting means is led to the condenser through a fiber.

3. The apparatus according to claim 1, wherein the light path interception means is tuned about a light axis at a face perpendicular to the light path to change a direction of the beam spot at an irradiated portion.

4. A method of jointing probes connected to a semiconductor integrated circuit so as to be conductive therewith to connection pads formed on a substrate by laser soldering, said method comprising:
trimming a beam spot of laser light by intercepting a part of light path of the laser light when the laser light is condensed to irradiate the laser light onto a jointing portion between the connection pads and the probes.

5. The method according to claim 4, wherein a direction of the beam spot at an irradiation portion is changed when a part of the light path of the laser light is intercepted.
